(19) United States
(12) Patent Application Publication
(10) Pub. No.: US 2017/0033429 A1
(43) Pub. Date: Feb. 2, 2017

(54) TUNABLE CAVITY RESONATOR

(71) Applicant: QUALCOMM Incorporated, San Diego, CA (US)

(72) Inventors: David Francis Berdy, San Diego, CA (US); Chengjie Zuo, San Diego, CA (US); Je-Hsiung Jeffrey Lan, San Diego, CA (US); Daeik Daniel Kim, Del Mar, CA (US); Changhan Hobie Yun, San Diego, CA (US); Mario Francisco Velez, San Diego, CA (US); Jonghae Kim, San Diego, CA (US)

(21) Appl. No.: 15/149,841

(22) Filed: May 9, 2016

Related U.S. Application Data
(60) Provisional application No. 62/199,759, filed on Jul. 31, 2015.

(51) Int. Cl. H01P 7/06; H01P 7/10

(52) U.S. Cl. CPC H01P 7/06; H01P 7/10

(57) ABSTRACT

An apparatus includes a tunable cavity resonator that includes conductive walls that form a tunable cavity. The tunable cavity has first dimensions when one or more phase change material layers within the tunable cavity have a first state. The tunable cavity has second dimensions when the one or more phase change material layers have a second state.

### I. CROSS-REFERENCE TO RELATED APPLICATIONS

The present application claims priority from U.S. Provisional Patent Application No. 62/199,759, filed on Jul. 31, 2015, entitled “TUNABLE CAVITY RESONATOR,” which is incorporated by reference in its entirety.

### II. FIELD

The present disclosure is generally related to tuning a resonant frequency of a resonator.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), tablet computers, and paging devices that are small, lightweight, and easily carried by users. Many such computing devices include other devices that are incorporated therein. For example, a wireless telephone can also include a digital still camera, a digital video camera, a digital recorder, and an audio file player. Also, such computing devices can process executable instructions, including software applications, such as a web browser application that can be used to access the Internet and multimedia applications that utilize a still or video camera and provide multimedia playback functionality.

A wireless device may communicate (e.g., send and receive signals) with one or more wireless devices using 5 Gigahertz (GHz) frequency band signaling. Inductor-capacitor (LC) circuits may be used to tune front-end components (e.g., radio frequency (RF) filters, matching networks, oscillators, etc.) of the wireless device to resonate at an operating frequency (e.g., 5 GHz). An increased number of inductors and capacitors may be coupled (e.g., “lumped”) together in a relatively dense area to tune the front-end components of the wireless device to higher operating frequencies. As a result, quality factors (Q) of the capacitors may degrade as the operating frequency increases. Quality factors (Q) of the inductors may increase as the operating frequency increases; however, parasitic capacitance becomes increasingly sizeable when coupling multiple inductors and capacitors in a relatively dense area.

### IV. SUMMARY

According to one implementation of the present disclosure, an apparatus includes a tunable cavity resonator that includes conductive walls that form a tunable cavity. The tunable cavity has first dimensions when one or more phase change material layers within the tunable cavity have a first state. The tunable cavity has second dimensions when the one or more phase change material layers have a second state.

According to another implementation of the present disclosure, a method for tuning a tunable cavity resonator includes applying a first heating profile to one or more phase change material layers of a cavity to tune the cavity to resonate at a first resonate frequency. The cavity is formed within the tunable cavity resonator by conductive walls. The method also includes applying a second heating profile to the one or more phase change material layers of the cavity to tune the cavity to resonate at a second resonate frequency.

According to another implementation of the present disclosure, a non-transitory computer-readable medium includes instructions for tuning a tunable cavity resonator. The instructions, when executed by a processor, cause the processor to perform operations including initiating application of a first heating profile to one or more phase change material layers of a cavity to tune the cavity to resonate at a first resonate frequency. The cavity is formed within the tunable cavity resonator by conductive walls. The operations also include initiating application of a second heating profile to the one or more phase change material layers of the cavity to tune the cavity to resonate at a second resonate frequency.

According to another implementation of the present disclosure, an apparatus includes means for tuning radio frequency (RF) signals and means for generating electromagnetic waves. The means for generating electromagnetic waves is formed within the means for tuning RF signals by conductive walls. The means for generating electromagnetic waves has first dimensions when one or more phase change material layers within the means for generating electromagnetic waves have a first state. The means for generating electromagnetic waves has second dimensions when the one or more phase change material layers have a second state.

### V. BRIEF DESCRIPTION OF THE DRAWINGS

FIG. 1 is a diagram of a tunable cavity that includes phase change material layers;

FIG. 2 depicts techniques for applying heating profiles to the phase change material layers to tune a resonant frequency of the tunable cavity of FIG. 1;

FIG. 3 is a diagram of a tunable cavity resonator that includes the tunable cavity of FIG. 1;

FIG. 4 is a flowchart of a method for tuning a tunable cavity resonator;

FIG. 5 is a block diagram of a device that includes the tunable cavity resonator of FIG. 3; and

FIG. 6 is a data flow diagram of a manufacturing process to manufacture electronic devices that include a tunable cavity having phase change material layers.

### VI. DETAILED DESCRIPTION

According to the techniques described herein, a tunable cavity resonator may be used to tune components of a wireless device to different resonant frequencies. As used herein, a “cavity resonator” and a “cavity filter” may be used interchangeably. A cavity resonator may include one or more “cavities” that are formed by low resistance conductive walls that have relatively high quality factors (Q). Each cavity may include electromagnetic waves that resonate at specific frequencies (e.g., resonant frequencies). Because the conductive walls of the cavities have relatively high quality factors (Q), a bandwidth (e.g., a range of frequencies around a resonant frequency) of each cavity (and thus a bandwidth of the cavity resonator) may be relatively narrow. The resonant frequency of the cavity resonator may be tuned by changing a size of one or more cavities. For example, the resonant frequency may be tuned by changing the dimensions of the low resistance conductive walls that form the cavities of the cavity resonator.

To change the size of a cavity in the cavity resonator, phase change material layers may be incorporated (e.g., integrated or included) in the cavity. As used herein, a “phase change material” may include a resistive material that is capable of transitioning between a crystalline state (e.g., a low-resistance state) and an amorphous state (e.g., a high-resistance state). The transition between these two states may be achieved using direct heating and/or indirect heating, both of which may include application of current (or voltage) pulses. In the direct heating approach, voltage may be directly applied to the phase change material. In the indirect heating approach, a separate conductive path may be used for the heater. As a non-limiting example, a heater line may be placed adjacent to the phase change material and current may propagate through the heater line to increase a temperature of the phase change material. According to one implementation, the phase change material layers may be comprised of Germanium Telluride (GeTe). The phase change material layers may switch from a low-resistance state (e.g., a conducting state) to a high-resistance state (e.g., an insulating state) by applying different heating profiles to the cavity. If a first heating profile is applied to the phase change material layers to switch the phase change material layers from the high-resistance state to the low-resistance state, the size of the cavity (e.g., the dimensions of the conductive walls) may reduce and the resonant frequency of the cavity may increase. If a second heating profile is applied to the phase change material layers to switch the phase change material layers from the low-resistance state to the high-resistance state, the size of the cavity may increase and the resonant frequency of the cavity may reduce.

One benefit of the disclosed techniques is an ability to tune front-end components of a wireless device to high resonant frequencies (e.g., 28 GHz, 60 GHz, etc.) without using circuit elements having low quality factors (Q) and high parasitic capacitances. For example, a tunable cavity resonator having a relatively high quality factor (Q) and a reduced parasitic capacitance (compared to an inductor-capacitor (LC) circuit) may be used to tune front-end components of the wireless device. A resonant frequency of the tunable cavity resonator may be adjusted by applying different heating profiles to phase change material layers incorporated into the cavities to enable the wireless device to communicate with other devices at different frequencies.

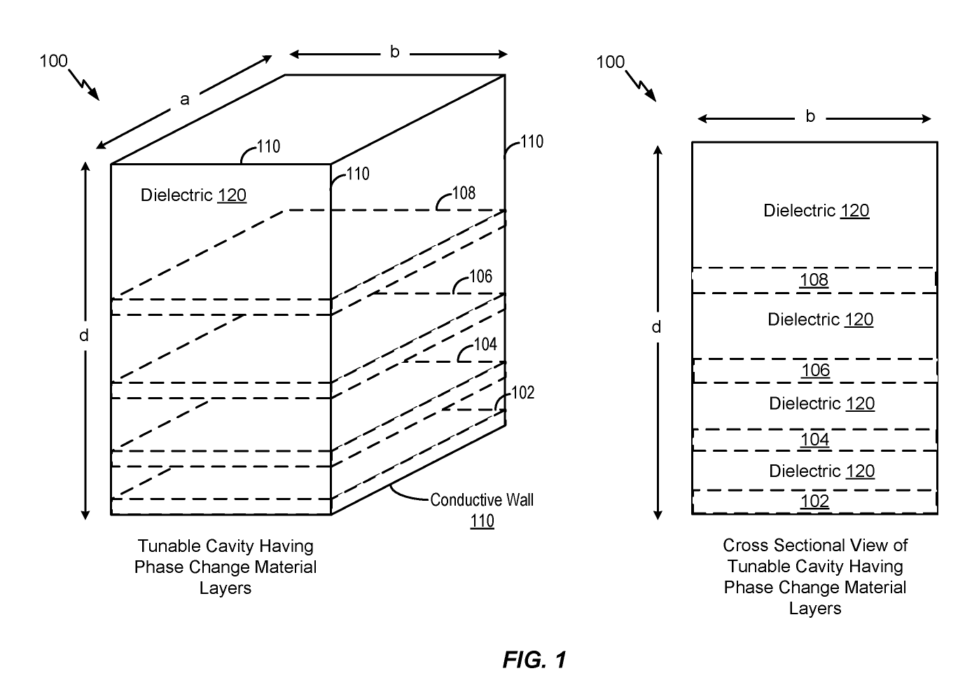

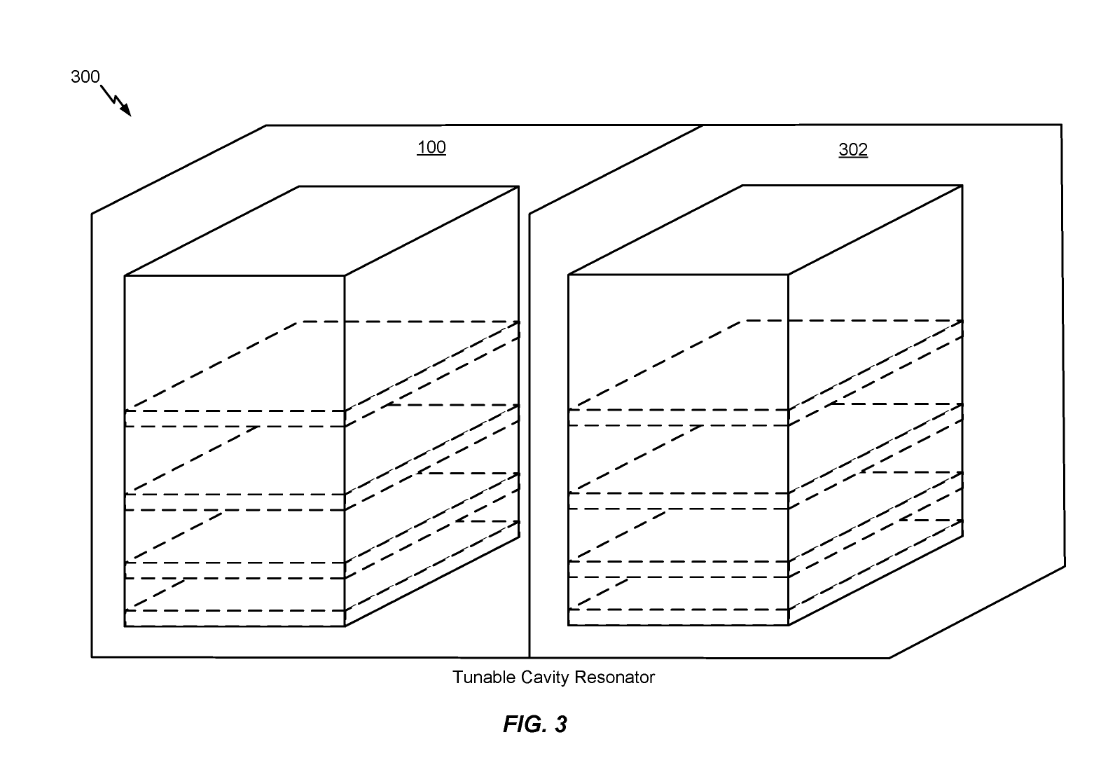

Referring to FIG. 1, a tunable cavity 100 that includes phase change material layers is shown. The tunable cavity 100 may be included in a tunable cavity resonator (or tunable cavity filter) that is operable to resonate at different radio frequencies. For example, the tunable cavity resonator may include the tunable cavity 100 and one or more other tunable cavities, as described in greater detail with respect to FIG. 3. FIG. 1 illustrates a three-dimensional view of the tunable cavity 100 and a cross-sectional view of the tunable cavity 100.

The tunable cavity 100 may be comprised of conductive walls 110. In the illustrative example of FIG. 1, the tunable cavity 100 may include six conductive walls 110 that are comprised of metal. For example, the conductive walls 110 may be comprised of Aluminum (Al), Titanium (Ti), Copper (Cu), Magnesium (Mg), Iron (Fe), other metals, or a combination thereof. Although the tunable cavity 100 has a cubical shape, in other implementations, tunable cavities in conjunction with the present disclosure may have other geometries. For example, tunable cavities in conjunction with the present disclosure may be spherical, may have additional conductive walls, may have fewer conductive walls, etc.

A first side of the tunable cavity 100 may have a length (a), a second side of the tunable cavity 100 may have a length (b), and a third side of the tunable cavity 100 may have a length (d). A resonant frequency of the tunable cavity 100 may be a function of the lengths (a, b, d). For example, the resonant frequency (fₘₙₗ) of the tunable cavity 100 may be expressed as:

$${f}_{mnl} = \frac{c}{2 \sqrt{{ɛ}_{r} {μ}_{r}}} \sqrt{{( \frac{m}{a} )}^{2} + {( \frac{n}{b} )}^{2} + {( \frac{l}{d} )}^{2}} . \qquad ( Equation 1 )$$

According to Equation 1, ∈ᵣ is the cavity material relative dielectric constant, μᵣ is the cavity material relative permeability, c is the speed of light, m is a constant indicating a resonant mode, n is a constant indicating the resonant mode, and l is a constant indicating the resonant mode. As indicated by Equation 1, the resonant frequency (fₘₙₗ) is inversely proportional to the size or dimensions (as expressed by the lengths (a, b, d)) of the tunable cavity 100. As the size of the tunable cavity 100 increases, the resonant frequency (fₘₙₗ) of the tunable cavity 100 decreases. As the size of the tunable cavity 100 decreases, the resonant frequency (fₘₙₗ) of the tunable cavity 100 increases.

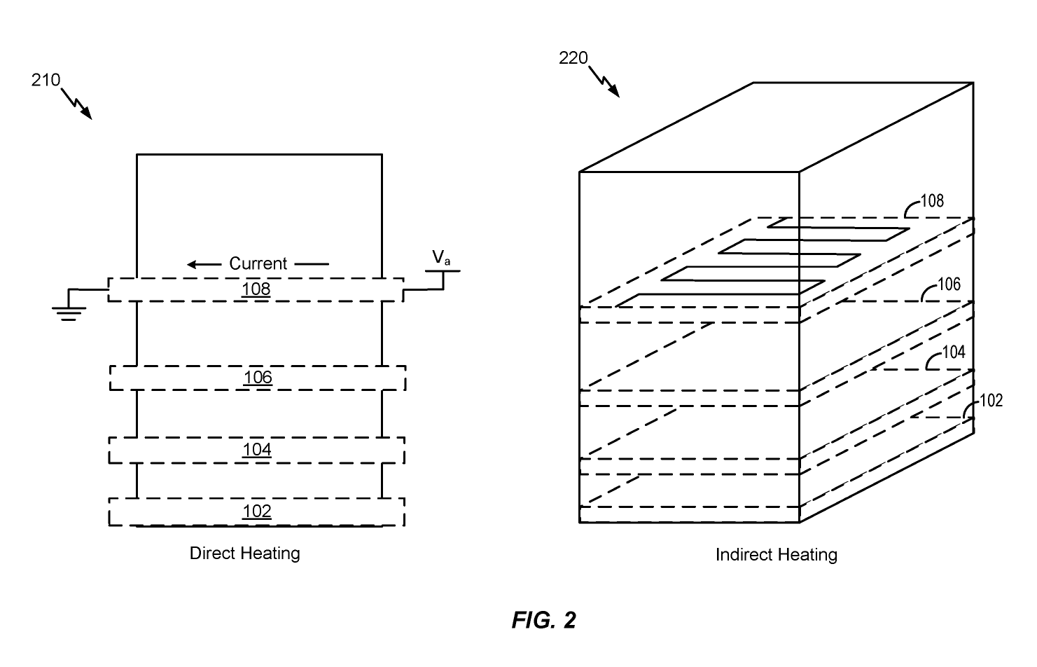

To change the size (e.g., the dimensions) of the tunable cavity 100, thus changing the resonant frequency (fₘₙₗ), phase change material layers 102, 104, 106, 108 may be integrated or included in the tunable cavity 100. According to one implementation, each phase change material layer 102, 104, 106, 108 may be comprised of Germanium Telluride (GeTe). One or more of the phase change material layers 102, 104, 106, 108 may switch from a first state (e.g., a low-resistance state or a conducting state) to a second state (e.g., a high-resistance state or an insulating state) by applying different heating profiles to the tunable cavity, as described in greater detail with respect to FIG. 2. If a first heating profile is applied to one or more of the phase change material layers 102, 104, 106, 108 to switch the phase change material layers 102, 104, 106, 108 from the second state to the first state, the size of the tunable cavity 100 (e.g., the length (d)) reduces and the resonant frequency (fₘₙₗ) of the tunable cavity 100 increases. If a second heating profile is applied to one or more of the phase change material layers 102, 104, 106, 108 to switch the phase change material layers 102, 104, 106, 108 from the first state to the second state, the size of the tunable cavity 100 (e.g., the length (d)) increases and the resonant frequency (fₘₙₗ) of the tunable cavity 100 reduces.

According to the illustrative example of FIG. 1, the phase change material layer 102 may be located toward the bottom of the tunable cavity 100, the phase change material layer 104 may be located above the phase change material layer 102, the phase change material layer 106 may be located above the phase change material layer 104, and the phase change material layer 108 may be located above the phase change material layer 106. The area in between the phase change material layers 102, 104, 106, 108 may be comprised of dielectrics (e.g., air, other dielectric materials, or a combination thereof). Although four phase change material layers 102, 104, 106, 108 are shown to be integrated into the tunable cavity 100, in alternative implementations, additional (or fewer) phase change material layers may be integrated into the tunable cavity 100. As a non-limiting example, fifteen phase change material layers or a single phase change material layer may be integrated into the tunable cavity 100.

Additionally, each phase change material layer 102, 104, 106, 108 in the tunable cavity 100 is shown to have a similar orientation as the orientation of the tunable cavity 100. For example, the width of each phase change material layer 102, 104, 106, 108 is substantially parallel to the width of the tunable cavity 100, the length of each phase change material layer 102, 104, 106, 108 is substantially parallel to the length of the tunable cavity 100, and the height of each phase change material layer 102, 104, 106, 108 is substantially parallel to the height of the tunable cavity 100. However, in other implementations, one or more phase change material layers in conjunction with the present disclosure may have orientations that are distinct from an orientation of a corresponding tunable cavity. For example, one phase change material layer may have a horizontal orientation, another phase change material layer may have a diagonal orientation, another phase change material layer may have a vertical orientation, etc.

The tunable cavity 100 of FIG. 1 may be used to tune front-end components of a wireless device without using a densely coupled inductive-capacitive (LC) circuit that may result in low quality factors (Q) (e.g., larger bandwidths) and high parasitic capacitances. The resonant frequency (fₘₙₗ) of the tunable cavity 100 may be adjusted by applying different heating profiles to phase change material layers 102, 104, 106, 108 to enable the wireless device to communicate with other devices at different frequencies.

Referring to FIG. 2, techniques for applying heating profiles to the phase change material layers 102, 104, 106, 108 to tune the resonant frequency (fₘₙₗ) of the tunable cavity 100 are shown. For example, a first technique 210 depicts a direct application of heat to the phase change material layers 102, 104, 106, 108, and a second technique 220 depicts an indirect application of heat to the phase change material layers 102, 104, 106, 108.

According to the first technique 210, a first terminal of one or more of the phase change material layers 102, 104, 106, 108 may be coupled to a first voltage terminal and a second terminal of one or more of the phase change material layers 102, 104, 106, 108 may be coupled to a second voltage terminal. In the illustrative example, a first terminal of the phase change material layer 108 may be coupled to ground, and a second terminal of the phase change material layer 108 may be coupled to receive an applied voltage (Vₐ). Current may flow through the phase change material layer 108 towards the ground if the applied voltage (Vₐ) has a greater voltage potential than ground.

To apply a first heating profile to the phase change material layer 108, the applied voltage (Vₐ) may be set to a first voltage level (e.g., a relatively high voltage level). After setting the applied voltage (Vₐ) to the first voltage level, a relatively large current may flow through the phase change material layer 108 causing an increased amount of heat at the phase change material layer 108. Based on the increased heat, the phase change material layer 108 may change from a high-resistance state (e.g., an insulating state) to a low-resistance state (e.g., a conductive state). As a result, the size (d) of the tunable cavity 100 may decrease and the resonant frequency (fₘₙₗof the tunable cavity 100 may increase.

To apply a second heating profile to the phase change material layer 108, the applied voltage (Vₐ) may be set to a second voltage level (e.g., a relatively low voltage level). After setting the applied voltage (Vₐ) to the second voltage level, a relatively small current may flow through the phase change material layer 108 causing a decreased amount of heat at the phase change material layer 108. Based on the decreased heat, the phase change material layer 108 may change from a low-resistance state (e.g., a conductive state) to a high-resistance state (e.g., an insulating state). As a result, the size (d) of the tunable cavity 100 may increase and the resonant frequency (fₘₗ) of the tunable cavity 100 may decrease.

According to the second technique 220, a polysilicon material or other resistive heater material may be placed relatively close to the phase change material layer 108. A voltage may be applied to the polysilicon material (or the other resistive heater material), and heating profiles may be indirectly applied to the phase change material layer 108 via the polysilicon material.

The techniques described with respect to FIG. 2 may enable dynamic tuning of the tunable cavity 100. For example, the first heating profile may be applied to one or more of the phase change material layers 102, 104, 106, 108 to switch the phase change material layers 102, 104, 106, 108 from the second state to the first state, and the size of the tunable cavity 100 (e.g., the length (d)) reduces and the resonant frequency (fₘₙₗ) of the tunable cavity 100 increases. Additionally, the second heating profile may be applied to one or more of the phase change material layers 102, 104, 106, 108 to switch the phase change material layers 102, 104, 106, 108 from the first state to the second state, and the size of the tunable cavity 100 increases and the resonant frequency (fₘₙₗ) of the tunable cavity 100 reduces.

Referring to FIG. 3, a tunable cavity resonator 300 having multiple tunable cavities is shown. The tunable cavity resonator 300 includes the tunable cavity 100 and a tunable cavity 302. The tunable cavity 302 may have substantially the same configuration as the tunable cavity 100 and may operate in a substantially similar manner. For example, the tunable cavity 302 may include phase change material layers that may receive different heating profiles to selectively tune the resonant frequency of the tunable cavity 302.

According to one implementation, each tunable cavity 100, 302 may be tuned to a different resonant frequency. As a non-limiting example, the tunable cavity 100 may be tuned to a resonant frequency of 28 GHz, and the tunable cavity 302 may be tuned to a resonant frequency of 60 GHz. To tune the tunable cavity 100 to a resonant frequency of 28 GHz, a heating profile may be applied to one or more of the phase change material layers 102-108 to change the phase change material layers 102-108 to an insulating material. To tune the tunable cavity 302 to a resonant frequency of 60 GHz, a heating profile may be applied to one or more of the phase change material layers of the tunable cavity 302 to change the phase change material layers to a conducting material.

The tunable cavity resonator 300 of FIG. 3 may operate as a band-pass or band-stop filter that is tuned to two or more resonant frequencies. In the illustrative example above, the tunable cavity resonator 300 may be tuned to resonate at 28 GHz and 60 GHz by applying different heating profiles to the tunable cavity 100 and the tunable cavity 302, respectively. According to some implementations, the tunable cavity resonator 300 may be used as a frequency diplexer in a wireless device or any other application where narrow bandwidths are used. For example, the conductive walls of the tunable cavities 100, 302 may generate a relatively high quality factor (Q) and a reduced parasitic capacitance, which may result in relatively narrow bandwidths for tuning front-end components of the wireless device.

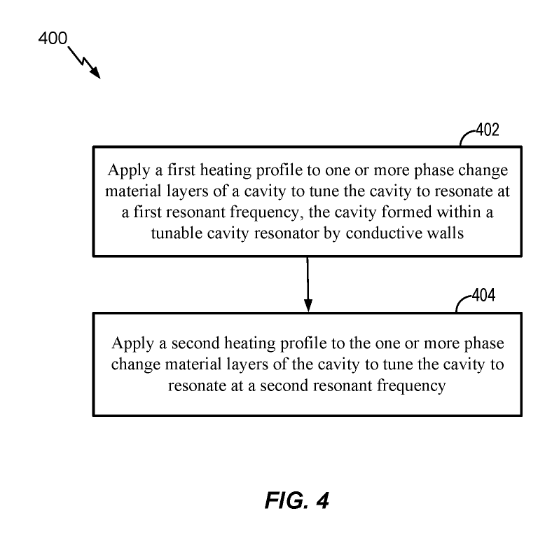

Referring to FIG. 4, a flowchart of a method 400 for tuning a tunable cavity resonator is shown. The method 400 may be performed using a processor (or other processing components) that are configured to apply different voltages (either directly or indirectly) to phase change material layers of a tunable cavity.

The method 400 includes applying a first heating profile to one or more phase change material layers of a cavity to tune the cavity to resonate at a first resonate frequency, at 402. The cavity may be formed within a tunable cavity resonator by conductive walls. For example, referring to FIG. 2, to apply the first heating profile to the phase change material layer 108, the applied voltage (Vₐ) may be set to a first voltage level (e.g., a relatively high voltage level). After setting the applied voltage (Vₐ) to the first voltage level, a relatively large current may flow through the phase change material layer 108 causing an increased amount of heat at the phase change material layer 108. Based on the increased heat, the phase change material layer 108 may change from a high-resistance state (e.g., an insulating state) to a low-resistance state (e.g., a conductive state). As a result, the size (d) of the tunable cavity 100 may decrease and the resonant frequency (fₘₙₗ) of the tunable cavity 100 may increase.

A second heating profile may be applied to the one or more phase change material layers of the cavity to tune the cavity to resonate at a second resonant frequency, at 404. For example, referring to FIG. 2, to apply a second heating profile to the phase change material layer 108, the applied voltage (Vₐ) may be set to a second voltage level (e.g., a relatively low voltage level). After setting the applied voltage (Vₐ) to the second voltage level, a relatively small current may flow through the phase change material layer 108 causing a decreased amount of heat at the phase change material layer 108. Based on the decreased heat, the phase change material layer 108 may change from a low-resistance state (e.g., a conductive state) to a high-resistance state (e.g., an insulating state). As a result, the size (d) of the tunable cavity 100 may increase and the resonant frequency (fₘₙₗ) of the tunable cavity 100 may decrease.

Thus, applying the first heating profile may include applying a first voltage to the one or more phase change material layers and applying the second heating profile may include applying a second voltage to the one or more phase change material layers. The second voltage may be less than the first voltage, and the first resonant frequency may be greater than the second resonant frequency. According to one implementation, the first resonant frequency may be approximately 60 GHz and the second resonant frequency may be approximately 28 GHz. According to the method 400, applying the first heating profile may reduce a size of the cavity and applying the second heating profile may increase the size of the cavity.

The method 400 of FIG. 4 may enable dynamic tuning of the tunable cavity 100. For example, the first heating profile may be applied to one or more of the phase change material layers 102, 104, 106, 108 to switch the phase change material layers 102, 104, 106, 108 from the second state to the first state, and the size of the tunable cavity 100 (e.g., the length (d)) reduces and the resonant frequency (fₘₙₗ) of the tunable cavity 100 increases. Additionally, the second heating profile may be applied to one or more of the phase change material layers 102, 104, 106, 108 to switch the phase change material layers 102, 104, 106, 108 from the first state to the second state, and the size of the tunable cavity 100 (e.g., the length (d)) increases and the resonant frequency (fₘₙₗ) of the tunable cavity 100 reduces.

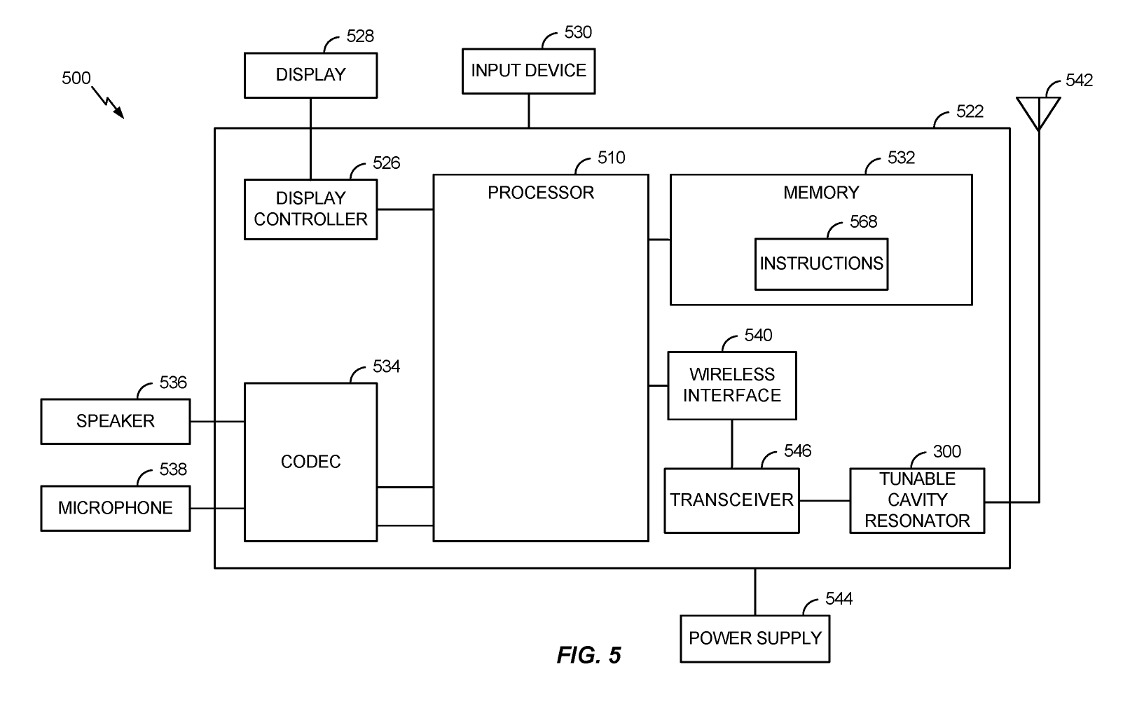

Referring to FIG. 5, a wireless communication device is depicted and generally designated 500. The device 500 includes a processor 510, such as a digital signal processor, coupled to a memory 532.

The processor 510 may be configured to execute software (e.g., a program of one or more instructions 568) stored in the memory 532. A wireless interface 540 may be coupled to the processor 510 and to a transceiver 546. A tunable cavity resonator, such as the tunable cavity resonator 300, may be coupled to the transceiver 546 and to an antenna 542. The tunable cavity resonator 300 may filter incoming and outgoing radio frequency (RF) signals. As a non-limiting example, the tunable cavity resonator 300 may include the tunable cavity 100 and the tunable cavity 302. The tunable cavity 100 may be tuned to a first resonant frequency by applying a first heating profile to the phase change material layers 102, 104, 106, 108, and the tunable cavity 302 may be tune to a second resonant frequency by applying a second heating profile to the phase change material layers of the tunable cavity 302. According to one implementation, the first resonant frequency may be approximately 28 GHz and the second resonant frequency may be approximately 60 GHz.

According to one implementation, the processor 510 may be configured to initiate application of a first heating profile to one or more phase change material layers (e.g., the phase change material layer 102, 104, 106, 108) of a cavity to tune the cavity at a first resonant frequency. The processor 510 may also be configured to initiate application of a second heating profile to the one or more phase change material layers of the cavity to tune the cavity to resonate at a second resonant frequency. The cavity may be formed within a tunable cavity resonator by conductive walls.

A coder/decoder (CODEC) 534 can also be coupled to the processor 510. A speaker 536 and a microphone 538 can be coupled to the CODEC 534. A display controller 526 can be coupled to the processor 510 and to a display device 528. In a particular implementation, the processor 510, the display controller 526, the memory 532, the CODEC 534, the wireless interface 540, the transceiver 546, and the tunable cavity resonator 300 are included in a system-in-package or system-on-chip device 522. In a particular implementation, an input device 530 and a power supply 544 are coupled to the system-on-chip device 522. Moreover, in a particular implementation, as illustrated in FIG. 5, the display device 528, the input device 530, the speaker 536, the microphone 538, the antenna 542, and the power supply 544 are external to the system-on-chip device 522. However, each of the display device 528, the input device 530, the speaker 536, the microphone 538, the antenna 542, and the power supply 544 can be coupled to one or more components of the system-on-chip device 522, such as one or more interfaces or controllers.

In conjunction with the described aspects, an apparatus includes means for tuning radio frequency (RF) signals. For example, the means for tuning RF signals may include the tunable cavity resonators of FIGS. 1-3 and 5.

The apparatus may also include means for generating electromagnetic waves. The means for generating electromagnetic waves may be formed within the means for tuning RF signals by conductive walls. The means for generating electromagnetic waves may have first dimensions when one or more phase change material layers within the means for generating electromagnetic waves have a first state. The means for generating electromagnetic waves may have second dimensions when the one or more phase change material layers have a second state. For example, the means for generating electromagnetic waves may include the tunable cavity 100 of FIGS. 1-3, the tunable cavity 302 of FIG. 3, and other tunable cavities having phase change material layers.

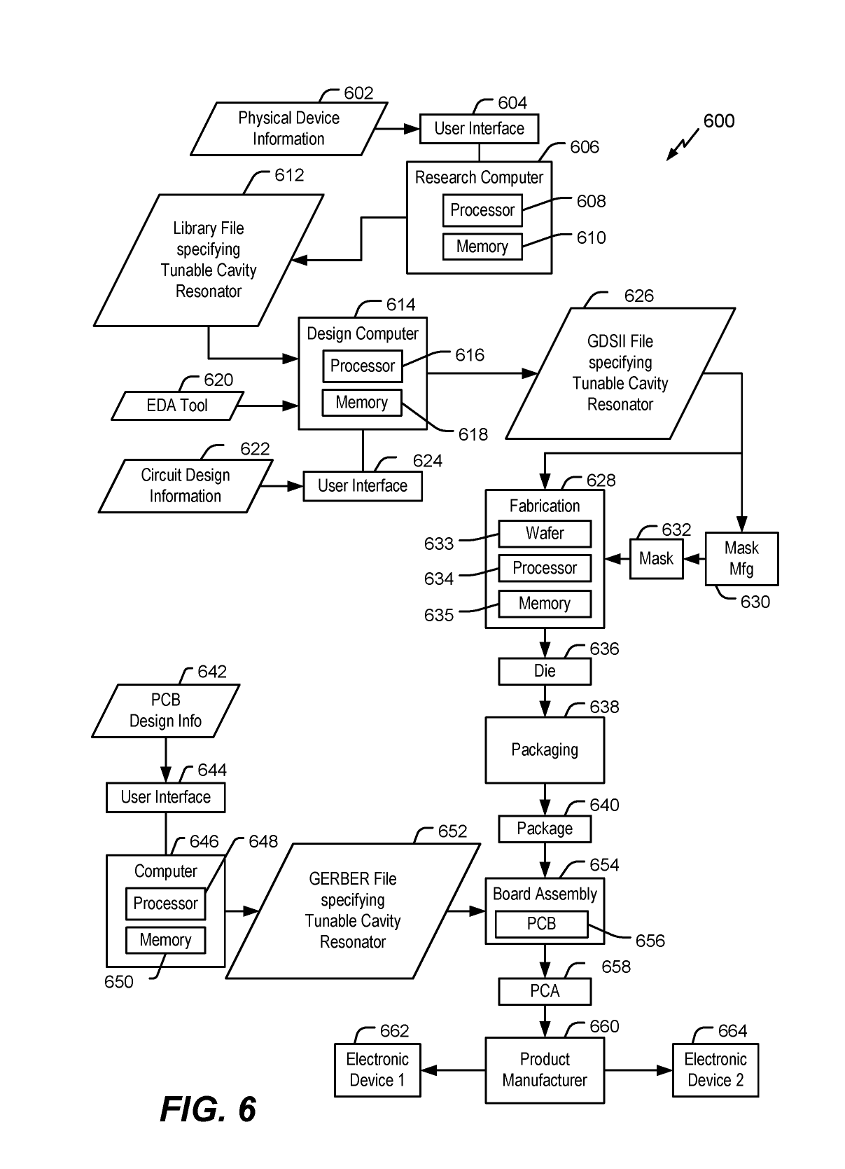

The foregoing disclosed devices and functionalities may be designed and configured into computer files (e.g., RTL, GDSII, GERBER, etc.) stored on computer-readable media. Some or all such files may be provided to fabrication handlers to fabricate devices based on such files. Resulting products include wafers that are then cut into dies and packaged into chips. The chips are then employed in devices described above. FIG. 6 depicts a particular illustrative implementation of an electronic device manufacturing process 600.

Physical device information 602 is received at the manufacturing process 600, such as at a research computer 606. The physical device information 602 may include design information representing at least one physical property of a semiconductor device, such as a physical property of a tunable cavity resonator that includes a tunable cavity having phase change material layers. For example, the physical device information 602 may include physical parameters, material characteristics, and structure information that is entered via a user interface 604 coupled to the research computer 606. The research computer 606 includes a processor 608, such as one or more processing cores, coupled to a computer-readable medium such as a memory 610. The memory 610 may store computer-readable instructions that are executable to cause the processor 608 to transform the physical device information 602 to comply with a file format and to generate a library file 612.

In a particular implementation, the library file 612 includes at least one data file including the transformed design information. For example, the library file 612 may include a library of semiconductor devices, including a tunable cavity resonator that includes a tunable cavity having phase change material layers, provided for use with an electronic design automation (EDA) tool 620.

The library file 612 may be used in conjunction with the EDA tool 620 at a design computer 614 including a processor 616, such as one or more processing cores, coupled to a memory 618. The EDA tool 620 may be stored as processor executable instructions at the memory 618 to enable a user of the design computer 614 to design a circuit including a tunable cavity resonator that includes a tunable cavity having phase change material layers, using the library file 612. For example, a user of the design computer 614 may enter circuit design information 622 via a user interface 624 coupled to the design computer 614. The circuit design information 622 may include design information representing at least one physical property of a semiconductor device, such as a tunable cavity resonator that includes a tunable cavity having phase change material layers. To illustrate, the circuit design property may include identification of particular circuits and relationships to other elements in a circuit design, positioning information, feature size information, interconnection information, or other information representing a physical property of an electronic device.

The design computer 614 may be configured to transform the design information, including the circuit design information 622, to comply with a file format. To illustrate, the file formation may include a database binary file format representing planar geometric shapes, text labels, and other information about a circuit layout in a hierarchical format, such as a Graphic Data System (GDSII) file format. The design computer 614 may be configured to generate a data file including the transformed design information, such as a GDSII file 626 that includes information describing a tunable cavity resonator that includes a tunable cavity having phase change material layers, in addition to other circuits or information. To illustrate, the data file may include information corresponding to a system-on-chip (SOC) or a chip interposer component that that includes a tunable cavity resonator that includes a tunable cavity having phase change material layers, and that also includes additional electronic circuits and components within the SOC.

The GDSII file 626 may be received at a fabrication process 628 to manufacture a tunable cavity resonator that includes a tunable cavity having phase change material layers according to transformed information in the GDSII file 626. For example, a device manufacture process may include providing the GDSII file 626 to a mask manufacturer 630 to create one or more masks, such as masks to be used with photolithography processing, illustrated in FIG. 6 as a representative mask 632. The mask 632 may be used during the fabrication process to generate one or more wafers 633, which may be tested and separated into dies, such as a representative die 636. The die 636 includes a tunable cavity resonator that includes a tunable cavity having phase change material layers.

In a particular implementation, the fabrication process 628 may be initiated by or controlled by a processor 634. The processor 634 may access a memory 635 that includes executable instructions such as computer-readable instructions or processor-readable instructions. The executable instructions may include one or more instructions that are executable by a computer, such as the processor 634.

The fabrication process 628 may be implemented by a fabrication system that is fully automated or partially automated. For example, the fabrication process 628 may be automated and may perform processing steps according to a schedule. The fabrication system may include fabrication equipment (e.g., processing tools) to perform one or more operations to form an electronic device.

The fabrication system may have a distributed architecture (e.g., a hierarchy). For example, the fabrication system may include one or more processors, such as the processor 634, one or more memories, such as the memory 635, and/or controllers that are distributed according to the distributed architecture. The distributed architecture may include a high-level processor that controls or initiates operations of one or more low-level systems. For example, a high-level portion of the fabrication process 628 may include one or more processors, such as the processor 634, and the low-level systems may each include or may be controlled by one or more corresponding controllers. A particular controller of a particular low-level system may receive one or more instructions (e.g., commands) from a high-level system, may issue sub-commands to subordinate modules or process tools, and may communicate status data back to the high-level system. Each of the one or more low-level systems may be associated with one or more corresponding pieces of fabrication equipment (e.g., processing tools). In a particular implementation, the fabrication system may include multiple processors that are distributed in the fabrication system. For example, a controller of a low-level system component of the fabrication system may include a processor, such as the processor 634.

Alternatively, the processor 634 may be a part of a high-level system, subsystem, or component of the fabrication system. In another implementation, the processor 634 includes distributed processing at various levels and components of a fabrication system.

The die 636 may be provided to a packaging process 638 where the die 636 is incorporated into a representative package 640. For example, the package 640 may include the single die 636 or multiple dies, such as a system-in-package (SiP) arrangement. The package 640 may be configured to conform to one or more standards or specifications, such as Joint Electron Device Engineering Council (JEDEC) standards.

Information regarding the package 640 may be distributed to various product designers, such as via a component library stored at a computer 646. The computer 646 may include a processor 648, such as one or more processing cores, coupled to a memory 650. A printed circuit board (PCB) tool may be stored as processor executable instructions at the memory 650 to process PCB design information 642 received from a user of the computer 646 via a user interface 644. The PCB design information 642 may include physical positioning information of a packaged electronic device on a circuit board, the packaged electronic device corresponding to the package 640 including a tunable cavity resonator that includes a tunable cavity having phase change material layers.

The computer 646 may be configured to transform the PCB design information 642 to generate a data file, such as a GERBER file 652 with data that includes physical positioning information of a packaged electronic device on a circuit board, as well as layout of electrical connections such as traces and vias, where the packaged electronic device corresponds to the package 640 including a tunable cavity resonator that includes a tunable cavity having phase change material layers. In other implementations, the data file generated by the transformed PCB design information may have a format other than a GERBER format.

The GERBER file 652 may be received at a board assembly process 654 and used to create PCBs, such as a representative PCB 656, manufactured in accordance with the design information stored within the GERBER file 652. For example, the GERBER file 652 may be uploaded to one or more machines to perform various steps of a PCB production process. The PCB 656 may be populated with electronic components including the package 640 to form a representative printed circuit assembly (PCA) 658.

The PCA 658 may be received at a product manufacturer 660 and integrated into one or more electronic devices, such as a first representative electronic device 662 and a second representative electronic device 664. As an illustrative, non-limiting example, the first representative electronic device 662, the second representative electronic device 664, or both, may be selected from a set top box, a music player, a video player, an entertainment unit, a navigation device, a communications device, a personal digital assistant (PDA), a fixed location data unit, and a computer, into which a tunable cavity resonator that includes a tunable cavity having phase change material layers, is integrated. As another illustrative, non-limiting example, referring to FIG. 6, one or more of the electronic devices 662 and 664 may be a wireless communication device. As another illustrative, non-limiting example, one or more of the electronic devices 662 and 664 may also be remote units such as mobile phones, hand-held personal communication systems (PCS) units, portable data units such as personal data assistants, global positioning system (GPS) enabled devices, navigation devices, fixed location data units such as meter reading equipment, or any other device that stores or retrieves data or computer instructions, or any combination thereof. Although FIG. 6 illustrates remote units according to teachings of the disclosure, the disclosure is not limited to these illustrated units. Implementations of the disclosure may be suitably employed in any device which includes active integrated circuitry including memory and on-chip circuitry.

A device that includes a semiconductor device described with reference to FIGS. 1-3, may be fabricated, processed, and incorporated into an electronic device, as described in the illustrative manufacturing process 600. One or more aspects of the implementations disclosed with respect to FIGS. 1-5 may be included at various processing stages, such as within the library file 612, the GDSII file 626, and the GERBER file 652, as well as stored at the memory 610 of the research computer 606, the memory 618 of the design computer 614, the memory 650 of the computer 646, the memory of one or more other computers or processors (not shown) used at the various stages, such as at the board assembly process 654, and also incorporated into one or more other physical implementations such as the mask 632, the die 636, the package 640, the PCA 658, other products such as prototype circuits or devices (not shown), or any combination thereof. Although various representative stages are depicted with reference to FIGS. 1-5, in other implementations fewer stages may be used or additional stages may be included. Similarly, the process 600 of FIG. 6 may be performed by a single entity or by one or more entities performing various stages of the manufacturing process 600.

Those of skill would further appreciate that the various illustrative logical blocks, configurations, modules, circuits, and algorithm steps described in connection with the implementations disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g. tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. An apparatus comprising:
a tunable cavity resonator comprising conductive walls that form a tunable cavity, the tunable cavity having first dimensions when one or more phase change material layers within the tunable cavity have a first state, and the tunable cavity having second dimensions when the one or more phase change material layers have a second state.

2. The apparatus of claim 1, wherein the first state is a conducting state or a low-resistance state.

3. The apparatus of claim 2, wherein the second state is an insulating state or a high-resistance state.

4. The apparatus of claim 3, wherein the first dimensions are smaller than the second dimensions.

5. The apparatus of claim 3, wherein the tunable cavity has a first resonant frequency when the one or more phase change material layers have the first state, and wherein the tunable cavity has a second resonant frequency that is lower than the first resonant frequency when the one or more phase change material layers have the second state.

6. The apparatus of claim 5, wherein the first resonant frequency is approximately 60 Gigahertz (GHz), and wherein the second resonant frequency is approximately 28 GHz.

7. The apparatus of claim 1, wherein the conductive walls are comprised of one or more metals.

8. The apparatus of claim 7, wherein the one or more metals include Aluminum (Al), Titanium (Ti), Copper (Cu), Magnesium (Mg), Iron (Fe), or a combination thereof.

9. The apparatus of claim 1, wherein the one or more phase change material layers are comprised of Germanium Telluride (GeTe).

10. A method for tuning a tunable cavity resonator, the method comprising:
applying a first heating profile to one or more phase change material layers of a cavity to tune the cavity to resonate at a first resonant frequency, the cavity formed within the tunable cavity resonator by conductive walls; and
applying a second heating profile to the one or more phase change material layers of the cavity to tune the cavity to resonate at a second resonant frequency.

11. The method of claim 10, wherein applying the first heating profile comprises applying a first voltage to the one or more phase change material layers, wherein applying the second heating profile comprises applying a second voltage to the one or more phase change material layers, and wherein the second voltage is less than the first voltage.

12. The method of claim 11, wherein the first resonant frequency is greater than the second resonant frequency.

13. The method of claim 12, wherein the first resonant frequency is approximately 60 Gigahertz (GHz), and wherein the second resonant frequency is approximately 28 GHz.

14. The method of claim 11, wherein applying the first heating profile reduces a size of the cavity, and wherein applying the second heating profile increases the size of the cavity.

15. The method of claim 11, wherein applying the first heating profile changes a state of at least one of the one or more phase change material layers to a conducting state or a low-resistance state.

16. The method of claim 11, wherein applying the second heating profile changes a state of at least one of the one or more phase change material layers to an insulating state or a high-resistance state.

17. The method of claim 10, wherein the conductive walls are comprised of one or more metals.

18. The method of claim 17, wherein the one or more metals include Aluminum (Al), Titanium (Ti), Copper (Cu), Magnesium (Mg), Iron (Fe), or a combination thereof.

19. The method of claim 10, wherein the one or more phase change material layers are comprised of Germanium Telluride (GeTe).

20. A non-transitory computer-readable medium comprising instructions for tuning a tunable cavity resonator, the instructions, when executed by a processor, cause the processor to perform operations comprising:
initiating application of a first heating profile to one or more phase change material layers of a cavity to tune the cavity to resonate at a first resonant frequency, the cavity formed within the tunable cavity resonator by conductive walls; and
initiating application of a second heating profile to the one or more phase change material layers of the cavity to tune the cavity to resonate at a second resonant frequency.

21. The non-transitory computer-readable medium of claim 20, wherein applying the first heating profile comprises applying a first voltage to the one or more phase change material layers, wherein applying the second heating profile comprises applying a second voltage to the one or more phase change material layers, and wherein the second voltage is less than the first voltage.

22. The non-transitory computer-readable medium of claim 21, wherein the first resonant frequency is greater than the second resonant frequency.

23. The non-transitory computer-readable medium of claim 22, wherein the first resonant frequency is approximately 60 Gigahertz (GHz), and wherein the second resonant frequency is approximately 28 GHz.

24. The non-transitory computer-readable medium of claim 21, wherein applying the first heating profile reduces a size of the cavity, and wherein applying the second heating profile increases the size of the cavity.

25. The non-transitory computer-readable medium of claim 21, wherein applying the first heating profile changes a state of the one or more phase change material layers to a conducting state or a low-resistance state.

26. The non-transitory computer-readable medium of claim 21, wherein applying the second heating profile changes a state of the one or more phase change material layers to an insulating state or a high-resistance state.

27. The non-transitory computer-readable medium of claim 20, wherein the one or more phase change material layers are comprised of Germanium Telluride (GeTe).

28. An apparatus comprising:
means for tuning radio frequency (RF) signals; and
means for generating electromagnetic waves, the means for generating electromagnetic waves formed within the means for tuning RF signals by conductive walls, the means for generating electromagnetic waves having first dimensions when one or more phase change material layers within the means for generating electromagnetic waves have a first state, and the means for generating electromagnetic waves having second dimensions when the one or more phase change material layers have a second state.

29. The apparatus of claim 28, wherein the first state is a conducting state or a low-resistance state, and wherein the second state is an insulating state or a high-resistance state.

30. The apparatus of claim 29, wherein the means for generating electromagnetic waves has a first resonant frequency when the one or more phase change materials have the first state, and wherein the means for generating electromagnetic waves has a second resonant frequency that is lower than the first resonant frequency when the one or more phase change material have the second state.
